(19) United States
(12) Patent Application Publication
(10) Pub. No.: US 2012/0280975 A1
(43) Pub. Date: Nov. 8, 2012

(54) Poly-view Three Dimensional Monitor

(76) Inventor: Stephen Alan Jeffryes, Houston, TX (US)

(21) Appl. No.: 13/100,296

(22) Filed: May 3, 2011

(51) Int. Cl. G06T 15/00

(52) U.S. Cl. 345/419

(57) ABSTRACT

A display device and a protocol for image preparation are described. The device comprises a transmissive liquid crystal display (LCD) screen, a panel of sequential lights and a control circuit to coordinate the display of images with the cyclical operation of the lamps of the light panel. The sequential operation of lamps in coordination with the changing images displayed on the LCD provides control of the color an intensity of light passing through any point in the LCD at any of a large number of angles. In this manner, it is possible to provide a stereoscopic view to the viewer without the use of parallax barriers, head tracking devices, glasses or goggles and, furthermore, to provide different stereoscopic views as the viewer changes position with relation to the device.

### BACKGROUND OF THE INVENTION

### Technical Field

The invention falls within the field of electric/electronic graphic displays, which field includes televisions, video monitors, computer monitors and graphic information displays. The invention falls within the sub-field of displays which provide a three dimensional image to the viewer.

Three dimensional displays have been developed using a variety of techniques.

Some displays have required that viewers wear special glasses in order to perceive stereovision; either anaglyphic displays employing lenses of different colors over the right and left eye to view overlapped, differentially color filtered right and left views or polarized lenses to view overlapped right and left views which are projected with light polarized on differing axes. Both of these methods provide a scene from a singular point of view. The anaglyphic displays are limited in the richness of perceived color because of the very color filters by which they function.

Some displays have a rapidly moving screen upon which images were projected in a sequence such that, as the moving screen swept a volume the sequential images, representing slices of an object, appeared to fill a volume of space as a solid object.

Autostereoscopic displays have employed parallax barriers or lenticular screens to separate the image viewed by the right eye from the image viewed by the left eye.

The device presented here provides multiple images which are controlled from moment to moment by the varying angle of light passing through an image screen which controls the color and intensity of light which is passed. For any position from which an eye vies the display, the light passing through any point on the screen passes through the screen at a specific angle and is controlled in color and intensity by the image displayed momentarily by the LCD. As the lamps illuminate sequentially in coordination with the sequential display of images by the LCD, each point on the display is made to pass light of controlled color and intensity along that straight light which lies between the eye and that point on the LCD screen.

### BRIEF SUMMARY OF THE INVENTION

The invention comprises a display unit and a video frame preparation format. The display comprises an LCD situated some fixed distance from and array of horizontally spaced lamps which will be illuminated sequentially and a control circuit, largely similar to the screen control circuit of a LCD television, but also including circuitry to illuminate the lamps, one at a time. As the lamps are illuminated sequentially, the light passing through any individual point on the LCD sweeps horizontally through a range of angles. In coordination with this horizontally varying angle of the light passing through each point, the images displayed by the LCD are specially formatted so that the light passing through each point is of similar color and intensity to that which passed through a point similarly positioned on an imaginary plane positioned in front of the original setting. For each lamp in the array, a specially formatted video frame will be displayed coincident with the illumination of that lamp. The frames which are displayed on the LCD are prepared by combining vertical slices from the images which represent the fields of view of an array of cameras spaced across in front of the original scene or, for computer graphics images, a set of corresponding images representing the virtual fields of view of an array of virtual cameras. The vertical slice taken from each field of view to compose a single video frame corresponds to the position of that lamp with whose illumination the frame will be displayed; that is, for that point in the lamp illumination cycle when the left-most lamp will be lit, the video frame which will be displayed will comprise the left-most strips from each field of view; when the center lamp will be lit, the video frame which will be displayed will comprise the center strips from each field of view; and when the right-most lamp will be lit, the video frame which will be displayed will comprise the right-most strips from each field of view, with the selection of strips changing smoothly and in correspondence with the lamp to be lit for all frames in between.

A line from a viewer's left eye through a chosen point on the LCD display will align with one lamp in the array. It will receive its image input from that image which is displayed in coincidence with the illumination of that lamp. A line from the viewer's right eye through the same point on the LCD display will align with a different lamp and will receive its image input t from that different image which is displayed in coincidence with the illumination of that different lamp. Thus the right and left eyes will receive different image inputs. This also means that, as the viewer moves to the left or right while viewing the display, the image inputs to each eye will change correspondingly.

### DESCRIPTION OF THE DRAWINGS

The present invention is illustrated by way of example, and not by way of limitation, in the figures of the accompanying drawings and in which:

FIG. 1 illustrates the components which compose the most basic form of the invention (embodiment 1) including the approximate relative positions of the components whose relative position is relevant. These components are a lamp array 1, a liquid crystal display 2 (LCD), a control circuit 3, an input signal 4, a signal 5 to the lamp array, a signal 6 to the LCD and an enclosure 7 sufficient to keep dust and light from the interior of the display device. This embodiment provides a 3D image when viewed by two horizontally separated eyes.

FIG. 2 illustrates the components (similarly named and numbered as those in FIG. 1) and general arrangement of a display device (embodiment 2) including the approximate relative positions of the components whose relative position is relevant. This embodiment provides a 3D image whether the viewing eyes are horizontally displaced, as in upright viewing, or vertically displaced, as when the viewer has rolled onto his or her side.

FIG. 3 illustrates the several steps involved in capturing data for three dimensional video signals and in converting that data within the display device to produce a three dimensional image. FIG. 3 is divided into images FIG. 3a, FIG. 3b and FIG. 3c. Each of the subfigures depicts a set 14, a horizontally displaced array (a horizontal row) of cameras 12, camera fields of view 11, an image processing system 10, video image frames 9, light rays 8 within the display device, and the video display device components 1 through 6.

FIG. 4 depicts the division of images into vertical strips and the recombination of those strips into images similar to the video frames suitable for display by the display device to produce 3D images.

FIG. 5 depicts a display whose width and height are a significantly greater than the depth and also shows the greater number and density of lamps which will be necessary for full image production.

### DETAILED DESCRIPTION

In order to explain the display and its method of operation, it is helpful to begin with an analogy.

If one were to view a setting through a plate glass window while standing in a particular position with one eye closed, for each point on every object in the setting, there would be a single line from said point to the viewer's eye, and that line would represent the path of a ray of light whose color is the color of that particular point on the object. Furthermore, that line of light of a particular color would intersect the window at a particular point and would pass through the glass at a particular angle. We could make a record of the color of light passing through that point on the window and the angle between the line and the window. Let us concentrate on that one point on the window.

If one were to view the setting through the same window, but from a different position, and a straight line were drawn from the eye of the viewer through that one point on the window, that line would continue to some point on some object in the setting. This line through that same point on the window would pass through the window at a particular angle, and the point in the setting at the other end of the line would be of some particular color, the angle, color and intensity of the light being different from such values as noted when the viewer was in the first position. We could make a record of the color of light seen from this second position and the angle between this new viewing line and the window.

This exercise could be repeated until the scene had been viewed from every possible position from left to right, and angle of light and color of light recorded for every point on the window.

If one were then to replace that window with a panel which has the ability to emit light from every point on it and emit that light at every angle, but could control the color and intensity of the light passing through each point based on the angle of the light emitted from that point, one would be able to replicate the view through the window from any position in front of the window.

The display device described herein will possess the ability to pass light through a very large number of very small points and to control the color and intensity of light passing from each point based on the angle at which the light is passed through the point.

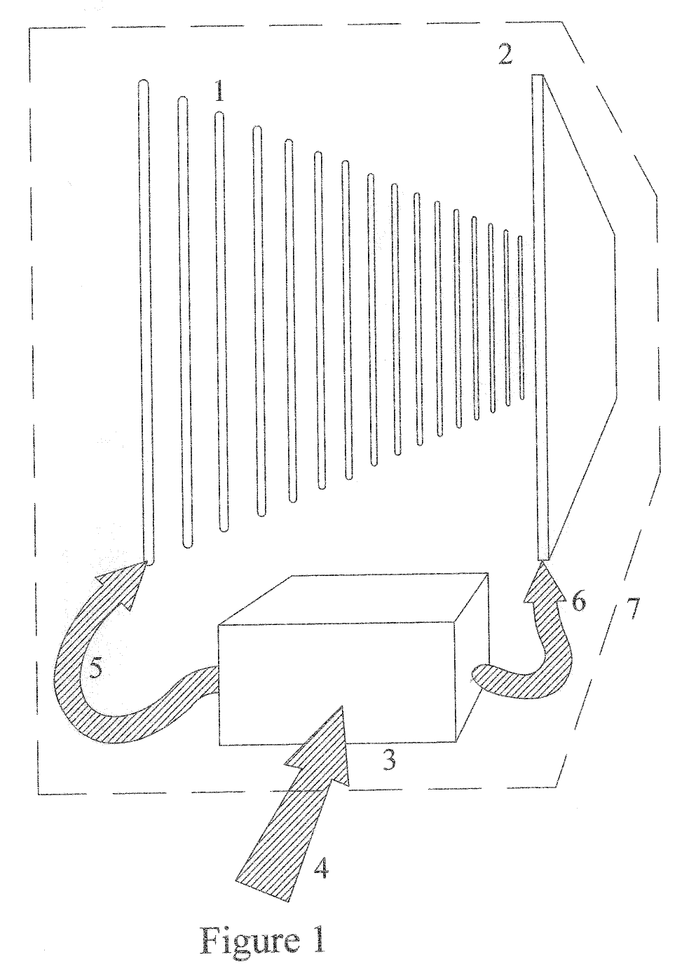

The display device will comprise a liquid crystal display (LCD) operated in a transmissive mode, an array of lamps which illuminate individually in a fixed sequence and control circuitry to receive a video signal and to send the necessary signals to the LCD to produce a graphic display. In one possible embodiment (FIG. 1), the lamps, 1, in the array would be in the form of vertical narrow lamps placed side by side across the width of the display and located some distance behind the LCD 2. These vertical lamps would be approximately as tall as the LCD, 2. The general arrangement of these components is as shown in FIG. 1, with the LCD 2 being on the viewed side of the device. The lamps 1 and LCD 2 will be controlled by control circuitry, 3, which will process the video input signal 4 to produce an output signal 5 to the lamp array and an output signal 6 to the LCD. These components would all be mounted in an enclosure 7 which will assure that the only light passing out the front of the LCD 2 will come from the lamp array 1. The most probable type of lamp for these vertical lamps may be long xenon tubes, but the exact type of bulb is not material to the claims herein.

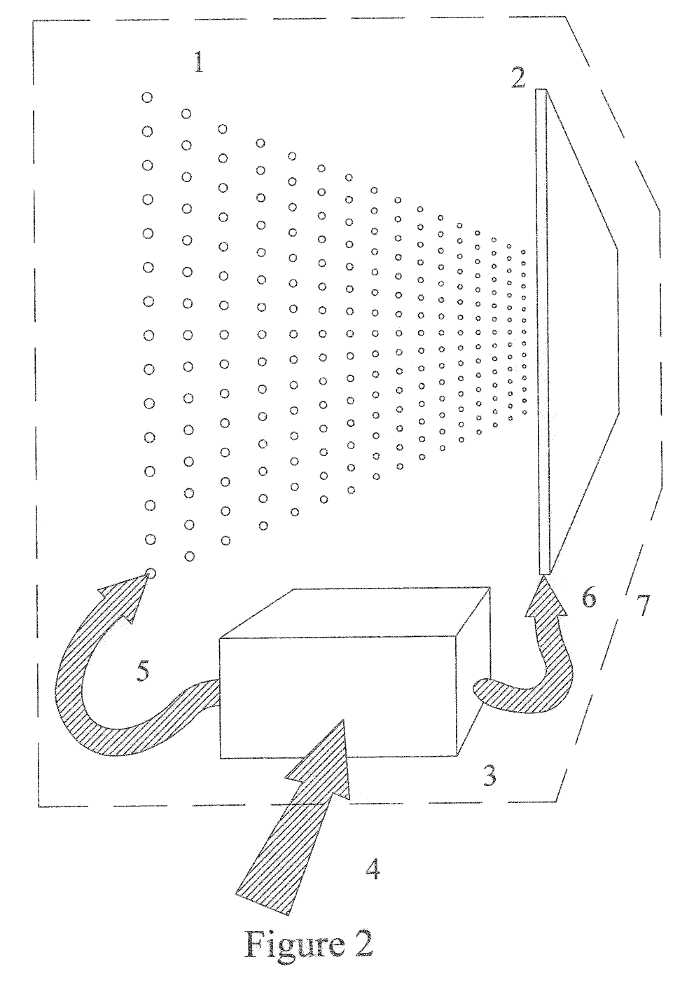

In another possible embodiment (FIG. 2), the lamp array 2 would comprise small bulbs arranged in rows and columns. Other components are similar to those in FIG. 1 and similarly numbered.

The design and operation of the control circuitry and the LCD are largely similar to the design and operation of the circuitry and LCD in an LCD television or computer monitor. The input signal will be largely similar to the input signal provided to any LCD display such as a television or computer monitor. There will be, however, two significant differences.

The first difference is that the control circuit will require and will make use of additional data imbedded in the video signal to turn the lamps in the lamp array on one at a time. This data could take the format of a numerical value representing the proper lamp to light. Alternatively, this data could be simply a line of data which, if delivered to the LCD display, would create a “white spot” on an otherwise “black” horizontal line. Rather than producing a black line with a white spot on the LCD, the control circuitry would read the horizontal displacement of the “white spot” to fire a lamp in a particular position.

The second difference from a conventional LCD display is that the images transmitted to and displayed upon the 3D display will be specifically formatted such that, at any point in time, when the LCD is illuminated from behind by a thin vertical lamp, the light passing through the LCD at every point is filtered for color and intensity by the LCD so that the light coming through at the particular horizontal angle established by the position of the lamp which is illuminated will match the color and intensity of the light which reached a vertical plane in front of the subject setting at the same angle.

In embodiment 1, as the display is illuminated with light coming from a particular horizontal displacement while the graphic displayed on the LCD is coordinated with the sequential illumination of the lamps, the display of a particular color at a particular fraction of maximum transparency at any point on the LCD while that point is illuminated by light coming from a particular lamp, and thus at a particular angle we have realized the control of color and intensity of light which is necessary to simulate the window, but only for horizontal variations in viewer position.

In embodiment 2, operation is similar, except that, by sequential illumination, one at a time, of the lamps arranged in a two dimensional grid, we gain control of the color and intensity of the light through any point as functions of both horizontal and vertical angles. This embodiment will require the processing of data at a much higher rate than will embodiment 1.

The graphic image displayed on the LCD must be formatted so that it provides, at any point in time, the proper color and intensity filtering for the light which will be passing through that point at the angle established by the illumination of the particular lamp which has been triggered at that point in time by the control circuitry.

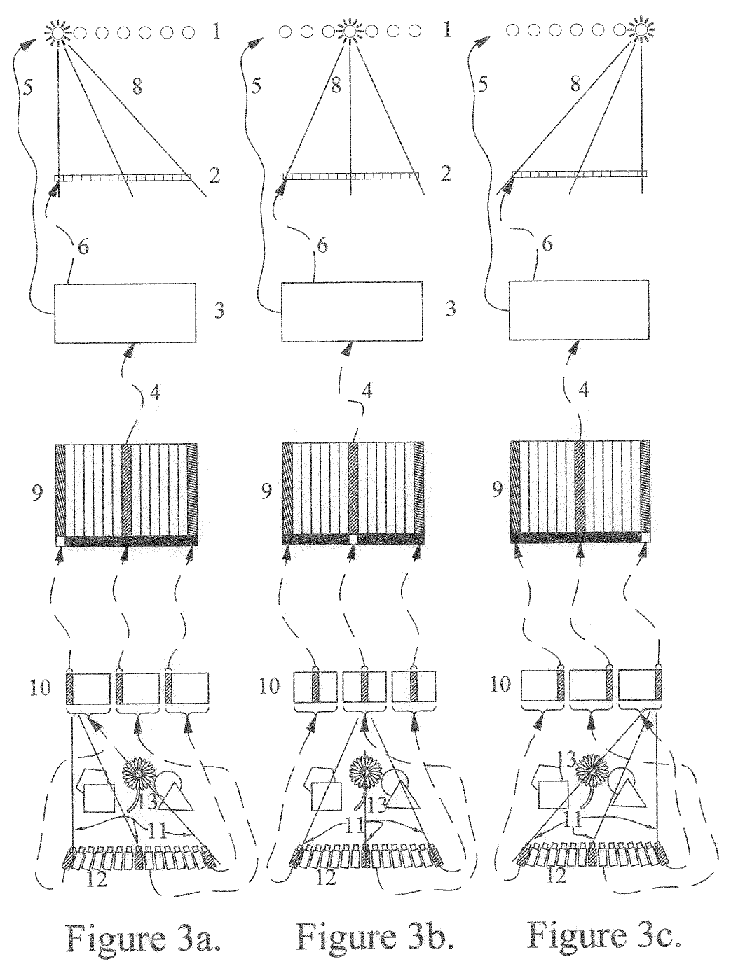

FIG. 3 depicts embodiment 1, showing the sequence from capturing image data at the source setting 14 by means of an array 12 of video cameras. Lines 13 represent paths of light from the setting to video cameras which will capture that light, and these line correlate with angles of rays of light 8 from the lamp which will be illuminated.

The sequences depicted in FIG. 3 begin with an array of cameras aimed at the setting. Each camera continuously views a fixed and full field of view and transmits the full field of view image 11 to a processing system 10. The processing system selects a vertical strip from the full picture from each camera and combines those vertical strips into a full screen width image 9. The vertical strip selected from each camera at any moment depends on the position of the lamp which will be illuminated when the combined image is displayed on the display device.

In FIG. 3a, an image will be prepared for display coincident with the illumination of the leftmost lamp. The fields of view 11 of three of the cameras are depicted with the left most strip of each highlighted. Lines 13 represent the lines of viewing which correspond to the lamp on the display device which will be lighted for display of the image to be prepared for this instant of viewing. These lines correspond to the angles of rays of light 8 from the lamp which will illuminate the LCD. The processing system 10 combines these image strips into a composite image 9. This composite image then becomes a frame of a video signal of any common video signal format. A line of phase angle data, represented by the white spot on the black line at the bottom of the combined vertical strips, is added to the image to identify which lamp should be lit when this frame is displayed. That data could take the formal of digital numerical data, or could simply be a “white spot” in a “black line” of data which is similar in format to that of the picture component of the signal. In the representation 8 of the combined strips, the white spot representing the phase angle data is located at the far left end of the phase angle data line at the bottom, corresponding to the lamp which must be illuminated to properly display this frame.

The signal is transmitted to the control circuit 3 of the 3D display device. The control circuit sends image control signals 6 to the LCD in exactly the manner that image signals are sent to the LCDs of televisions and computer monitors. The control circuitry also reads the phase angle data and sends a signal 5 to switch on the proper lamp for a very brief period.

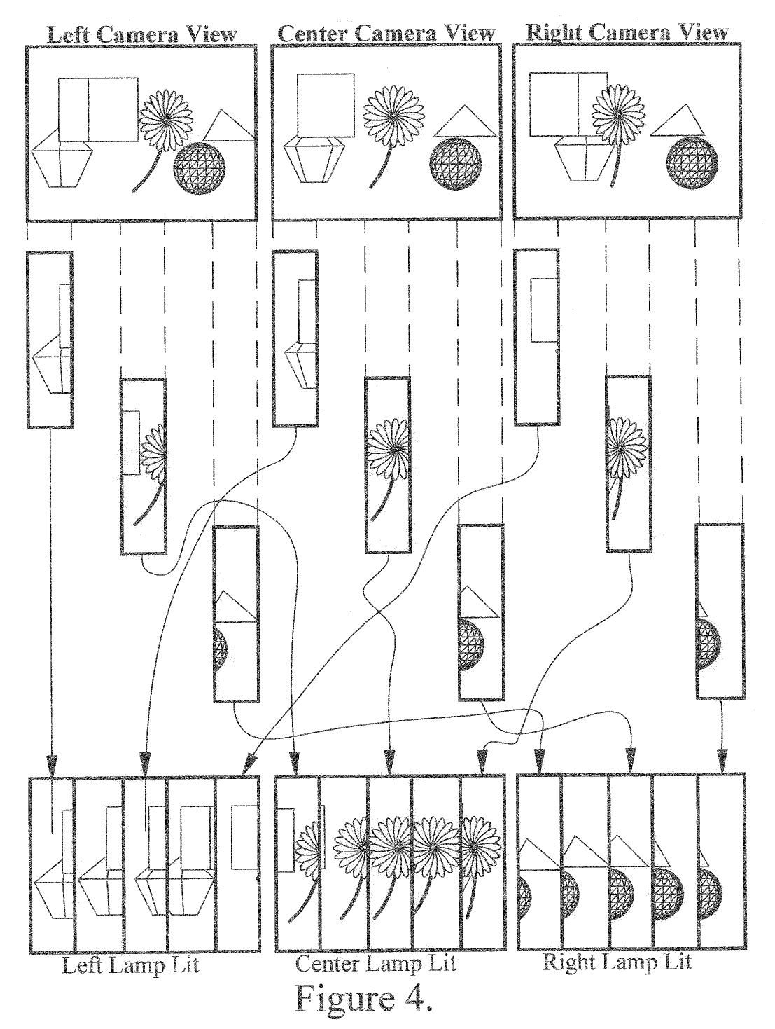

An example of the fields of view of the cameras being divided into vertical strips and recombined to produce images to be displayed coincident with the illumination of the left, center an right lamps is shown in FIG. 4. Those these images are shown, for clarity, being divided into five vertical, in practice, video frames would be composed of many more vertical strips.

In FIG. 3b, the system has progressed through half of a cycle. This point in the image production/reproduction cycle calls for an image to be prepared for display coincident with the illumination of the center lamp. Again, we see the correspondence between the angle of illumination of the LCD and the lines of viewing of the cameras which represent the center portion of each camera's field of view which will be incorporated as vertical strips into the video frame which is to be displayed at this moment in the display cycle. The white spot representing the phase angle data is located at the center of the phase angle data line. Again, this frame is transmitted as a frame of video imagery to the display device, the video frame is displayed, and the control circuit reads the phase angle data to switch on the center lamp. The angle of illumination of the LCD thus corresponds with the vertical image strips which were incorporated into the current frame.

### Current Frame.

The sequence is similar in FIG. 3c. The angles of viewing correspond to the far right portions of each camera's field of view which are incorporated as vertical strips into a video frame, along with phase angle information represented as a white spot at the far right end of the phase angle data line. This frame of video data is displayed coincident with the illumination of the far right lamp of the display device.

In between the preparation and display of the video frames depicted in FIGS. 3a, 3b and 3c, other frames representing many intermediate points in the cycle are similarly prepared and displayed. Each frame will include a strip of image from each camera in the array

The operations of FIG. 3a, FIG. 3b and FIG. 3c and the intermediate operations are repeated cyclically. The length of the cycle would be very short and repeated with a high enough frequency that the discrete frames are perceived as a continuous image, in the manner of a motion picture.

The exact number of vertical strips in each frame will determine the distance from which the display may be viewed and the effect of a 3D image be perceived. The greater number of strips into which each camera's field of view is divided and the greater number of vertical strips incorporated into each frame, the greater the distance from which the 3D image may be effectively perceived, as the required angular divisions of the displayed field of view are equal to one angle of a triangle whose hypotenuse is the distance from the display and whose opposite side is the distance between the viewers eyes. At highest possible angular resolution, the vertical strips might be a single pixel wide. Such resolution demands a very large data stream. For viewing from as far away as ten feet, and assuming that the display should have an effective viewing field of 45° right or left of head on, it should be sufficient to divide the image from each camera into about 60 strips. This provides for each strip to provide an image to 1.5° of the viewing area. From 120 inches (ten feet) away, the width of the displacement from the image provided by one strip to the image provided by another strip will be 3.14 inches, about the distance between an adult's eyes.

The angular resolution will in any case be limited by the number of video cameras trained upon the setting. There cannot be more vertical strips in the displayed image than there are cameras in the camera array, unless the display device provides interpolation between display images.

The sequence of operations depicted in FIG. 3 is for the preparation and display of images using an array of horizontally displaced cameras to produce images to be displayed on a device with a lamp array comprising a single row of vertical lamps, resulting in an image which provides a 3D effect only when viewed by horizontally displaced eyes. If the sequence is performed using an array of cameras arranged in both rows and columns, and the picture from each camera is divided into rows and columns of square patches rather than a row of vertical strips, if the vertical displacement of the square patches is taken into account in recombining the patches to create a video frame in the same manner that horizontal displacement of the vertical strips was taken into account in the sorting and recombination of the vertical strips to create a video frame, and if the video frame with both horizontal displacements taken into account were to be displayed on a device (embodiment 2) which has rows and columns of lamps which are operated in sequence and in coordination with the displayed video images, an image may be produced which provides a 3D effect when the viewing eyes are displaced horizontally or vertically or at any angle in between. Such an effect may be valued where the possibility exists that viewers might observe the device at varying angles from an upright position. Examples of such cases are displays for amusement park rides and flight simulators.

The description of the working of the 3D display device has, up to this point, described the capturing of images from a physical setting to produce the video frames which are transmitted to the display device. Using the analog convention of referring to computer graphics points of view as cameras, it is easy to see that the video frames which suit this 3D display may be generated as computer graphics images of a virtual setting.

Thin Designs

FIG. 2 depicts a display which is about as deep, front to back, as it is wide. In this configuration, every lamp position from left to right acts upon every pixel in the LCD from left to right. For purposes of describing the requirements of a thin display, we will refer to the deep display as a “boxy” display.

If the assembly is made very thin compared to its width, only a small fraction of the display width may be effectively illuminated at any instant, as there will be a very large deviation from a right angle in the angle between the position of illumination and portions of the display which are further removed form the position of illumination. When light meets a surface at an angle which is very many degrees different from a 90° angle, the light has a much greater tendency to reflect than to pass through the surface.

Nonetheless, with flat panel displays having been established as a more convenient configuration for a graphics display device than a boxy one, it is desirable to minimize the depth of the devices constructed based on the ideas first presented here. A matte black coating over all components inside the monitor cabinet other than the lamps and the backside of the LCD would reduce the emergence of scattered light, improving the quality of dark portions of the images.

In the figures representing the invention, the distance between the light array and the LCD is comparable to the width of the LCD. With a thin design, the distance between the LCD and the light array will be small compared to the width of the LCD. For any position of lateral displacement upon the LCD, only the lamps which are located within a narrow strip behind that position can be effective in illumination and, for any lamp which is lit, only a small portion of the LCD will be active contemporary with the illumination of that lamp, as shown in FIG. 5. If we look at the width of the LCD which may be inactive at any instant, that width of the LCD must be illuminated from as many angles as would be the whole screen of the boxy display. In order to maintain image quality by providing that each position upon the LCD is illuminated from just as many angles as would be provided in a boxy display, it will be necessary to employ a much denser array of (possibly) much narrower lamps. It will probably also be necessary to increase the scan rate to overcome any tendency for the overall display to exhibit a wave like effect from left to right.

Curved Designs

The methods described above may be readily applied to the creation of a display which is curved rather than flat. A collection of cylindrically convex displays may be assembled to create a cylindrical display which may be viewed from any position around the display. A collection of cylindrically concave displays may be assembled to create a cylindrical display which would surround the viewers. A collection of spherically convex displays may be assembled to create a spherical display to be viewed from the outside, while a collection of spherically concave displays may be assembled to create a display which surrounds the viewers on all sides and above and even below.

1. A video display device whose components are selected and arranged and interconnected in a novel and unique way so as to facilitate the sequential display of still images in such a way as to produce the perception of three dimensional images, including moving images, when viewed by a person with binocular vision.

2. A still image preparation format which provides the images which, when viewed in rapid sequence upon the device, will produce the desired perception of a scene which has height, width and depth, commonly referred to as “three dimensions” or “3D”.
